(19) United States
(12) Patent Application Publication
(10) Pub. No.: US 2004/0117281 A1
(43) Pub. Date: Jun. 17, 2004

(54) Method and system for bulk selling and banking a volume of fuel

(76) Inventor: Glenn Clydesdale, Thornhill (CA)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/321,770

(22) Filed: Dec. 17, 2002

(51) Int. Cl. G06F 17/60

(52) U.S. Cl. 705/35

(57) ABSTRACT

A method and system for bulk selling and banking a volume of fuel is provided, the method comprising the steps of selling a volume of fuel from a fuel selling location; creating a banking record of the sale; receiving the banking record at a fuel dispensing location, affiliated with the fuel selling location, and a request to dispense a portion of the volume purchased, which is less than the volume purchased; dispensing the requested portion; and, amending the banking record to reflect the remaining volume of sold fuel available for further dispensing. The banking record may include a measure of the volume of fuel available for dispensing and authentication information, such as purchaser identification information, transaction number, authentication code and combinations thereof. A method of verifying the received banking record is also provided.

### FIELD OF THE INVENTION

This invention relates to fuel purchasing, generally. In particular, this invention relates to bulk purchasing and banking a volume of fuel.

### BACKGROUND OF THE INVENTION

An individual's decision to purchase a fuel, such as gasoline, is often influenced by at least three variables. The first is the present price per unit volume of the fuel. Second is an estimation of the individual's future fuel requirements. Third is the likelihood that the price of the fuel will change in the near future. For example, if the price per liter of gasoline is particularly high, but an individual has enough gasoline in the gas tank to last several more days, the individual may postpone the purchase of fuel in the hopes of the price decreasing in the near future. Alternately, if the cost per liter is particularly low and the individual has enough gas in the tank to last several more days, the individual may decide to purchase fuel and “top up” the tank in anticipation of the price of gas increasing.

Of these variables, the present price per unit volume is a known variable and the individual purchaser may reliably predict his or her future fuel requirements. Unfortunately, it is not possible to reliably predict the future price of the fuel, especially if the price tends to vary significantly over relatively short periods of time, such as in the case of automobile fuel such as diesel, gasoline, propane, etc. As a result, individuals tend to exhibit opportunistic and sometimes irrational gas purchasing behaviour; i.e., they often seize the opportunity to purchase gasoline at a low price (often when there is no immediate need for the fuel). There remains a need to free purchasers from the effects of short term significant fluctuations in fuel prices.

### SUMMARY OF THE INVENTION

The present invention provides a method for bulk selling and banking a volume of fuel comprising the steps of selling a volume of fuel from a fuel selling location; creating a banking record of the sale; receiving the banking record at a fuel dispensing location, affiliated with the fuel selling location, and a request to dispense a portion of the volume purchased, which is less than the volume purchased; dispensing the requested portion; and, amending the banking record to reflect the remaining volume of sold fuel available for further dispensing.

The method may include the further step of transmitting a copy of the banking record to a central data store for storage.

The banking record includes a measure of the volume of fuel available for dispensing and authentication information, such as purchaser identification information, transaction number, authentication code and combinations thereof.

The present invention further provides a method of verifying the received banking record comprising the steps of receiving the banking record; querying a banking record database for a stored banking record corresponding to the received banking record; comparing the stored banking record with the received banking record; verifying that the received banking record matches the stored banking record; and, confirming that the measure of the volume of fuel available for dispensing is at least equal to the requested volume of fuel.

The present invention also provides a system for bulk selling and banking a volume of fuel comprising a fuel selling location for selling a volume of fuel to a purchaser, wherein the fuel selling location includes a banking record creator for creating a banking record of the sold fuel; and, a fuel dispensing location, affiliated with the fuel selling location, for receiving the banking record and, a request to dispense a portion of the volume purchased, which is less than the volume purchased, and a dispenser for dispensing the requested portion, wherein the fuel dispensing location includes a transaction manager for amending the banking record to reflect the volume of sold fuel available for further dispensing.

The transaction manager may further include a receiver for receiving the banking record; a database query engine for querying a banking record database for a stored banking record corresponding to the received banking record; a comparer for comparing the stored banking record with the received banking record; a verifier for verifying that the received banking record matches the stored banking record; and, a confirmer for confirming that the measure of the volume of fuel available for dispensing is at least equal to the requested volume of fuel.

### BRIEF DESCRIPTION OF THE DRAWINGS

Preferred embodiments of the present invention are described below with reference to the accompanying drawings in which:

FIG. 1 is a schematic view illustrating a system for bulk selling and banking a volume of fuel according to the present invention;

FIG. 2 is a schematic view illustrating the elements of a banking record for use in a method and system of bulk selling and baking a volume of fuel according to the present invention;

FIG. 3 is a schematic view illustrating a system for verifying a received banking record when the banking record, a banking record database and a verifier are located locally according to the present invention;

FIG. 4 is a schematic view illustrating a system for verifying a received banking record when the banking record and a verifier are located at separate location from a banking record database according to the present invention;

FIG. 5 is a schematic view illustrating a system for verifying a received banking record when the banking record is located at separate location from a verifier and a banking record database according to the present invention; and,

FIG. 6 is a flow chart view illustrating the steps in a method for bulk selling and banking a volume of fuel according to the present invention;

### DETAILED DESCRIPTION

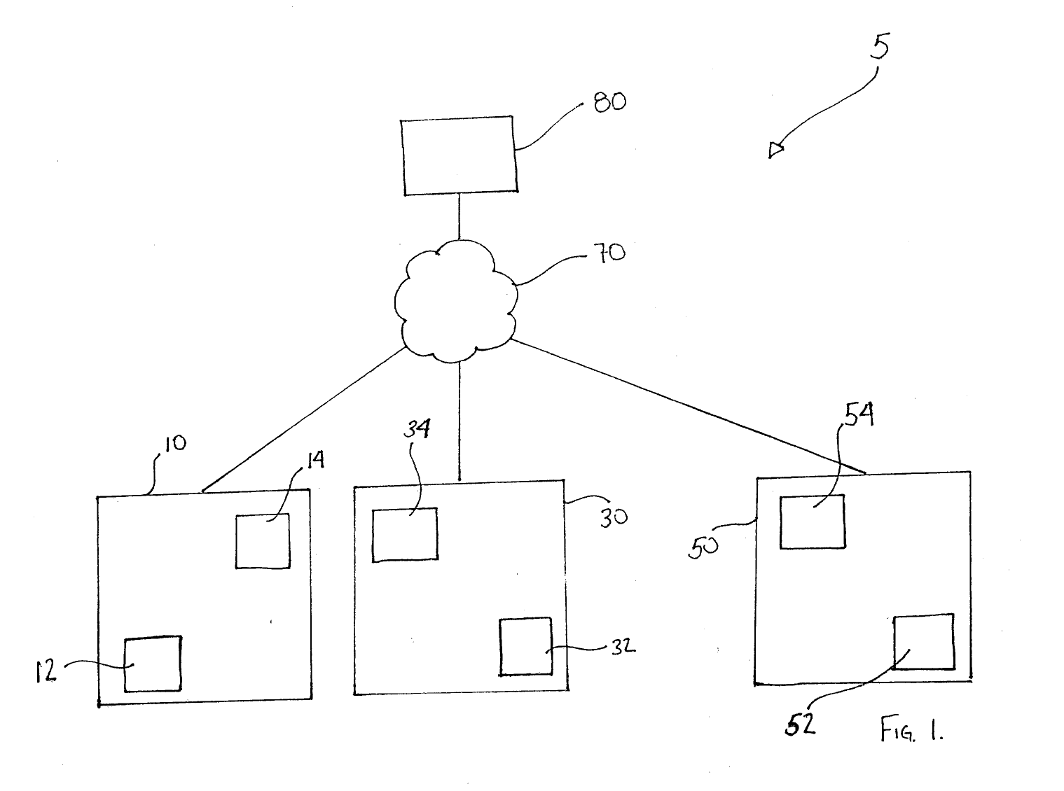

FIG. 1 illustrates a System generally indicated by reference 5 in accordance with a preferred embodiment of the invention.

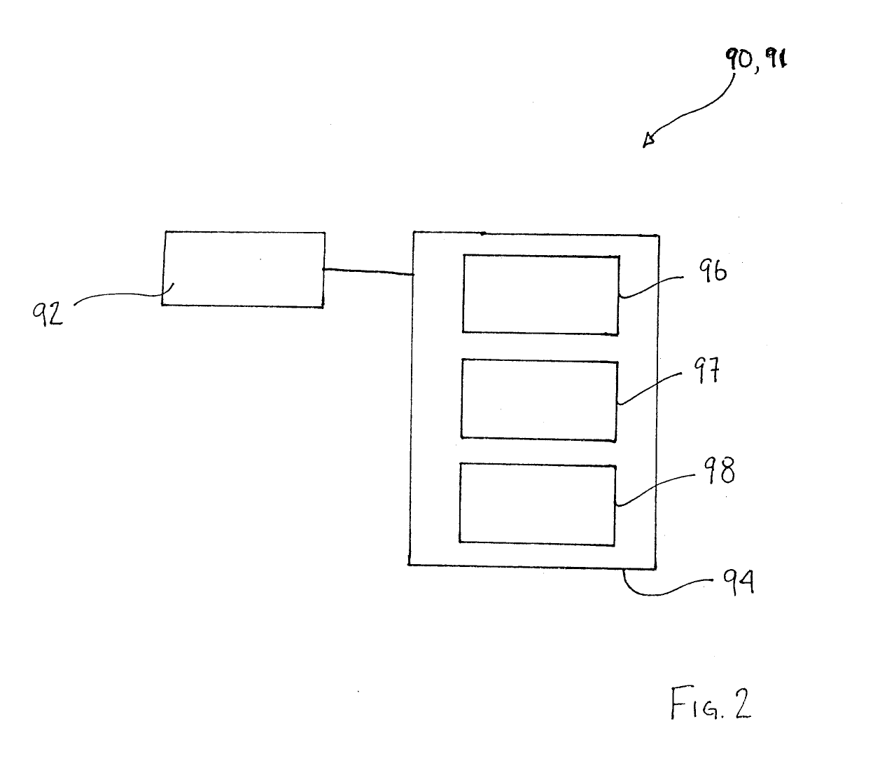

Referring to FIGS. 1 and 2, the System 5 is a system for bulk selling and banking a volume of fuel comprising a fuel selling location (FSL) 10 for selling a volume of fuel to a purchaser, wherein the FSL 10 includes a banking record creator 12 for creating a banking record 90 of the sold fuel; a central data store (CDS) 30 for storing a copy of the banking record 90 as a stored banking record 91 in a banking record database 32; and, a fuel dispensing location (FDL) 50, affiliated with the FSL 10, for receiving the banking record 90 and a request to dispense a portion of the volume purchased, which is less than the volume purchased, and a fuel dispenser 52 for dispensing the requested portion, wherein the FDL 50 includes a transaction manager 54 for amending the banking record 90 to reflect the volume of sold fuel available for further dispensing. In a preferred embodiment, FSL 10, CDS 30 and FDL 50 are located at different locations, but may communicate and transfer information between each other via a communication network 70. The communication network 70 may be a telephone network. In a preferred embodiment, the communication network is a data transmission network, such as the Internet. In an alternate embodiment, FSL 10, CDS 30 and FDL 50 are located at the same location.

The fuel sold at the FSL 10 may be gasoline, diesel, propane, natural gas, electricity, hydrogen and fuel oil, and combinations thereof. In a preferred embodiment, the fuel sold is gasoline, FSL 10 is a gas station and the gasoline is sold at a price per unit volume, which is advertised at the FDL 50. Alternately, the price per unit volume is advertised at the FSL 10. The price per unit volume is advertised using an advertiser (not shown), which may be a sign, visible to members of the public that displays the price per unit volume of the fuel available for sale.

In a further preferred embodiment, the FSL 10 is remote from the FDL 50, and may be accessed from a remote communication device 80, such as a stand-alone kiosk at a shopping mall, which is in communication with the FSL 10 via the communication network 70. In an alternate embodiment, the communication device 80 may be a telephone, desktop computer, notebook computer, handheld computer, cellular telephone or two-way pager. In this embodiment, the price per unit volume is made available over the communication network 70 to a user operating the communication device 80.

Referring to FIG. 2, the banking record 90 includes a measure of the volume of fuel available for dispensing 92 and authentication information 94. The authentication information 94 may include purchaser identification information 96, a transaction number 97, an authentication code 98 or combinations thereof. The authentication code may be an alphanumeric string of digits generated using a proprietary algorithm at the time the fuel is sold, which may then be validated at the FDL 50 prior to dispensing the requested volume of fuel.

The banking record 90 may be a paper record, such as a receipt or at least one coupon denoting at least a portion of the volume of fuel purchased, which is redeemed for a portion of the volume purchased. In this case, the banking record creator 12 may be a cash register, of a type known to those skilled in the art that prints and issues a receipt. In an alternate embodiment, the cash register may also issue a number of coupons having volume denominations, the total of which equals the volume of fuel sold at the FSL 10.

In a preferred embodiment, the banking record 90 is an electronic record. In an alternate embodiment, the banking record 90 is stored as both a paper record and an electronic record. The electronic record is stored on a non-volatile computer readable medium, such as a smart card or a magnetic strip on a card; the smart card having an embedded microprocessor and non-volatile computer readable memory. In a preferred embodiment, a copy of the banking record 90 is transmitted via a transmitter 14 to the CDS 30 and stored in the banking record database 32 as stored banking record 91.

In a further embodiment, a fuel purchaser may obtain the smart card or magnetic strip card from a third party, such as an independent retailer, but not purchase any fuel at the time the card is obtained. The purchaser purchases the fuel at another time when the desired fuel is available at an acceptable price per unit volume. The card may be purchased for a nominal fee. Alternately, the purchaser may subscribe to or join a fuel purchase club or program and the card is issued to the fuel purchaser as a membership card.

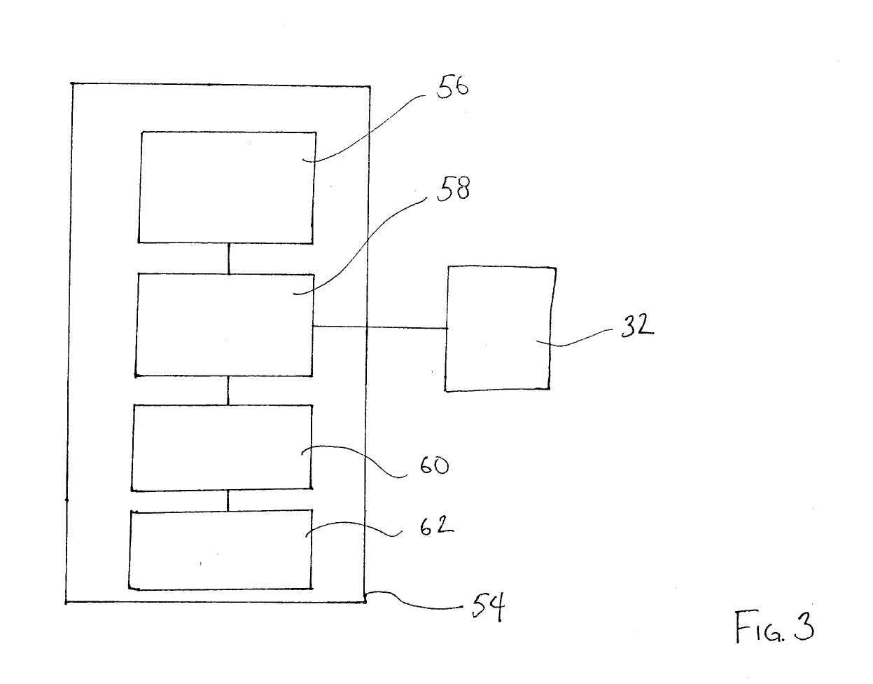

Referring to FIG. 3, the transaction manager 54 further includes a receiver 56 for receiving the banking record 90; a database query engine 58 for querying a banking record database 32 for a stored banking record 91 corresponding to the received banking record 90; a comparer 60 for comparing the stored banking record 91 with the received banking record 90 and verifying that the authentication information 94 of the received banking 90 record matches the authentication information of the stored banking record 91; and, a confirmer 62 for confirming that the measure of the volume of fuel available for dispensing 92 is at least equal to the requested volume of fuel.

The receiver 56, which may be a magnetic strip reader, bar code reader, smart card reader, or any other computer reader known to those skilled in the art capable of reading computer readable media, receives and reads the received banking record 90. A database query engine 58 then queries a banking record database 32 for a stored banking record 91 corresponding to the received banking record 90. The banking record 91 may be stored in any data management system known to those skilled in the art, such as SQL SERVER 2000 by MICROSOFT CORPORATION of Redmond, Wash., USA. If the query engine 58 retrieves a corresponding stored banking record 91, then the comparer 60 compares the stored banking record 91 with the received banking record 90 and verifies that the authentication information of the respective records match. For example, the comparer 60 may verify that the purchaser identification information 96 of the respective banking records matches. If the respective records have matching authentication information, then the confirmer 62 confirms that the measure of the volume of fuel available for dispensing 92 is at least equal to the requested volume of fuel. The requested volume of fuel is then dispensed with the dispenser 52, which may be a gas pump, or any other fuel dispensing means known to those skilled in the art. The database query engine 58, comparer 60 and confirmer 62 may be sub-routines of the same database management system, as is known to those skilled in the art. Alternately, they may be individual and separate proprietary applications that interact with a database management system.

In a preferred embodiment, the transaction manger 54 and the banking record database 32 are located at the FDL 50. Thus, the banking record 90 is received and verified at the FDL 50.

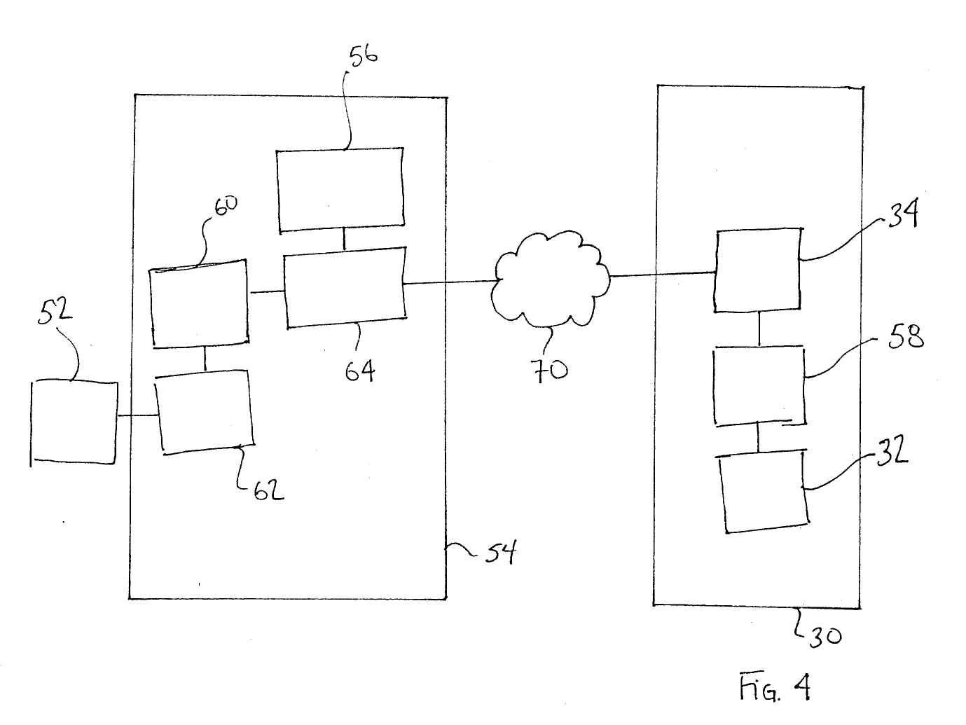

In an alternate embodiment, depicted in FIG. 4, the banking record 90 is received and verified at the FDL 50, but the banking record database 32 is stored in a remote CDS 30. In this case, the receiver 56 receives banking record 90. An FDL transmitter/receiver 64 then transmits the received banking record 90 via the communication network 70 to the CDS 30 where it is received by a CDS transmitter/receiver 34 and sent to the database query engine 58. The banking record database 32 is then queried for a stored banking record 91 corresponding to the received banking record 90. If a corresponding stored banking record 91 is retrieved, it is then transmitted to the comparer 60 via the communication network 70 for verification and the confirmer 62 for confirmation of the volume of fuel available for dispensing and the requested fuel is dispensed with the dispenser 52.

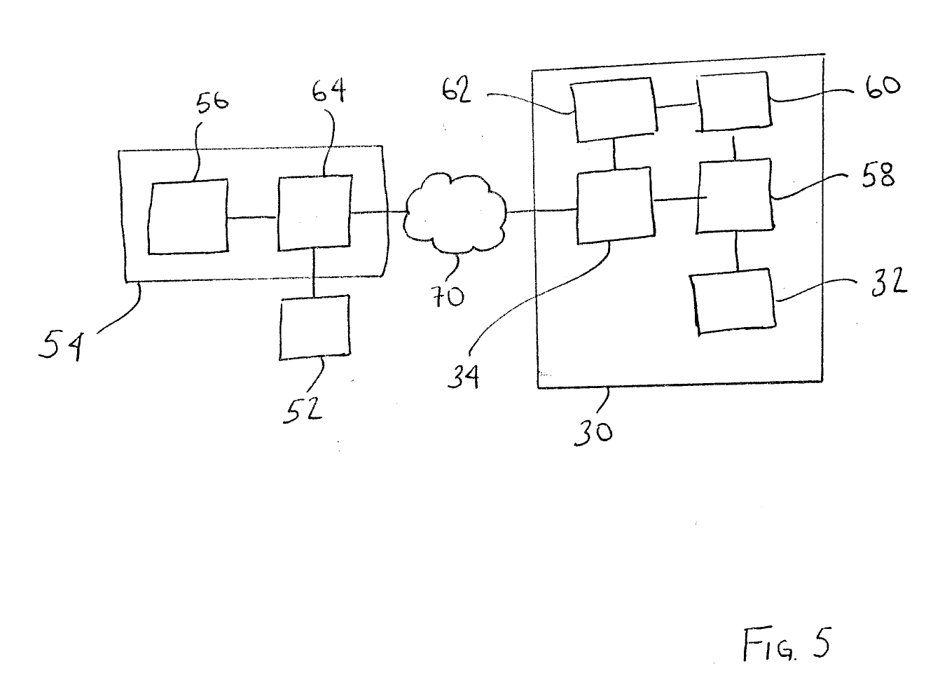

In a further alternate embodiment, depicted in FIG. 5, the banking record 90 is received at the FDL 50, but the record 90 is verified at the remote CDS 30, which is also the location for the banking record database 32. In this case, the receiver 56 receives the banking record 90. The FDL transmitter/receiver 64 then transmits the received banking record 90 via the communication network 70 to the CDS 30 where it is received by the CDS receiver/transmitter 34 and sent to the database query engine 58. The banking record database 32 is then queried for a stored banking record 91 corresponding to the received banking record 90. If a corresponding stored banking record 91 is retrieved, it is then passed on to the comparer 60 for verification and the confirmer 62 for confirmation of the volume of fuel available for dispensing. Verification and confirmation information is then transmitted to the FDL 50 via the communication network 70 and the requested fuel is dispensed with the dispenser 52.

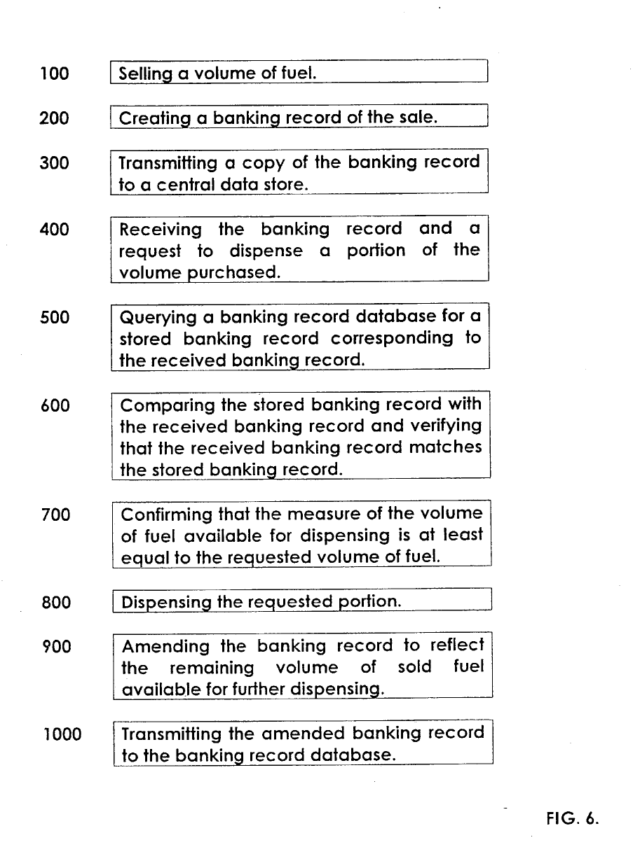

Referring to FIG. 6, a method for bulk selling and banking a volume of fuel is discussed. An individual wishing to purchase a volume of fuel attends at a FSL 10, which may be a gas station, FDL 50, or from a remote location via a communication device 80, and determines an amount of fuel to purchase. At step 100, the FSL 10 sells the requested volume of fuel to the individual. Once payment for the requested fuel is received, a banking record creator 12 creates a banking record 90 of the sale (step 200). In a preferred embodiment of the invention, the a banking record 90 is issued to the purchaser and a copy of the banking record 90 is transmitted to a banking record database 32 and stored as a stored banking record 91 (step 300).

At step 400, an individual attends at a FDL 50 affiliated with the FSL 10, and requests to dispense a portion of the volume purchased, which is less than the volume purchased. On receiving the request and the banking record 90, the banking record database 32 is queried for a stored banking record 91 that corresponds to the received banking record 90 (step 500). If a corresponding record is retrieved, then at step 600 a comparer 60 compares the received banking record 90 with the retrieved banking record to determine if the authentication information 94 of the respective banking records match. If they match, then at step 700 a confirmer 62 confirms that the measure of the volume of fuel available for dispensing is at least equal to the requested volume of fuel. The requested volume of fuel is dispensed at step 800. After the volume of fuel is dispensed, the banking record is amended to reflect the volume of fuel available for further dispensing (step 900), a copy of the amended record is then transmitted to the banking record database 32 (step 1000).

The present invention is defined by the claims appended hereto, with the foregoing description being illustrative of the preferred embodiments of the invention. Those of ordinary skill may envisage certain additions, deletions and/or modifications to the described embodiments, which, although not explicitly suggested herein, do not depart from the scope of the invention, as defined by the appended claims. For example, the banking record 90 may be parsed into its constituent elements and these elements may be stored in separate databases. Alternately, there may be no CDS 30 and the banking record 90 is issued to and remains with only the purchaser until it is redeemed.

What is claimed is:

1. A method for bulk selling and banking a volume of fuel comprising the steps of:
a. selling a volume of fuel from a fuel selling location;
b. creating a banking record of the sale;
c. receiving the banking record at a fuel dispensing location, affiliated with the fuel selling location, and a request to dispense a portion of the volume purchased, which is less than the volume purchased;
d. dispensing the requested portion; and,
e. amending the banking record to reflect the remaining volume of sold fuel available for further dispensing.

2. The method of claim 1, wherein step b. includes the further step of transmitting a copy of the banking record to a central data store for storage.

3. The method of claim 1, wherein the banking record includes a measure of the volume of fuel available for dispensing and authentication information.

4. The method of claim 1, wherein the authentication information is a member of the group consisting of purchaser identification information, transaction number, authentication code and combinations thereof.

5. The method of claim 4, wherein the received banking record is verified, the verification comprising the steps of:
a. receiving the banking record;
b. querying a banking record database for a stored banking record corresponding to the received banking record;
c. comparing the stored banking record with the received banking record;
d. verifying that the received banking record matches the stored banking record; and,
e. confirming that the measure of the volume of fuel available for dispensing is at least equal to the requested volume of fuel.

6. The method of claim 5, wherein the received banking record is verified at the fuel dispensing location.

7. The method of claim 5, wherein the received banking record is transmitted to a remote location.

8. The method of claim 7, wherein the transmitted banking record is verified at a remote location.

9. The method of claim 1, wherein the fuel sold is a member of the group consisting of gasoline, diesel, propane, natural gas, electricity, hydrogen and fuel oil, and combinations thereof.

10. The method of claim 1, wherein the fuel selling location is a gas station.

11. The method of claim 1, wherein the fuel selling location is remote from the fuel dispensing location.

12. The method of claim 1, wherein the fuel is sold at a price per unit volume.

13. The method of claim 12, wherein the price per unit volume is advertised at the fuel selling location.

14. The method of claim 12, wherein the price per unit volume is advertised at the fuel dispensing location.

15. The method of claim 12, wherein the price per unit volume is made available over a communication network to a user operating a communication device.

16. The method of claim 15, wherein the communication network is a telephone network.

17. The method of claim 15, wherein the communication network is a data transmission network.

18. The method of claim 15, wherein the communication device is a member of the group consisting of telephone, desk-top computer, notebook computer, handheld computer, cellular telephone and two-way pager.

19. The method of claim 1, wherein the banking record is a paper record.

20. The method of claim 19, wherein the paper record is a receipt.

21. The method of claim 19, wherein the paper record is at least one coupon denoting at least a portion of the volume of fuel purchased, which is redeemed for at least a portion of the volume purchased.

22. The method of claim 1, wherein the banking record is stored on a computer readable medium.

23. The method of claim 22, wherein the computer readable medium is a magnetic strip of a card.

24. The method of claim 22, wherein the electronic record is stored on a card having an embedded microprocessor and computer readable memory.

25. A system for bulk selling and banking a volume of fuel comprising:
a. a fuel selling location for selling a volume of fuel to a purchaser, wherein the fuel selling location includes a banking record creator for creating a banking record of the sold fuel; and,
b. a fuel dispensing location, affiliated with the fuel selling location, for receiving the banking record and a request to dispense a portion of the volume purchased, which is less than the volume purchased, and a dispenser for dispensing the requested portion, wherein the fuel dispensing location includes a transaction manager for amending the banking record to reflect the volume of sold fuel available for further dispensing.

26. The system of claim 25, wherein the fuel selling location further includes a transmitter for transmitting a copy of the banking record to a banking record database.

27. The system of claim 25, wherein the banking record database is stored in a central data store.

28. The system of claim 25, wherein the banking record includes a measure of the volume of fuel available for dispensing and authentication information, and said authentication information is a member of the group consisting of purchaser identification information, transaction number, authentication code and combinations thereof.

29. The system of claim 28, wherein the transaction manager further includes:
a. a receiver for receiving the banking record;
b. a database query engine for querying a banking record database for a stored banking record corresponding to the received banking record;
c. a comparer for comparing the stored banking record with the received banking record and for verifying that the received banking record matches the stored banking record; and,
d. a confirmer for confirming that the measure of the volume of fuel available for dispensing is at least equal to the requested volume of fuel.

30. The system of claim 29, wherein the central data store is located at the fuel dispensing location.

31. The system of claim 29, wherein the central data store is located at a remote location.

32. The system of claim 31, wherein a transmitter transmits the received banking record to the central data store at the remote location.

33. The system of claim 25, wherein the fuel selling location is a gas station.

34. The system of claim 25, wherein the fuel selling location is a remote location.

35. The system of claim 25, wherein the fuel selling location further includes an advertiser for advertising that the fuel is sold at a price per unit volume.

36. The system of claim 25, wherein the fuel dispensing location further includes an advertiser for advertising that the fuel is sold at a price per unit volume.

37. The system of claim 25, wherein the banking record is a paper record.

38. The system of claim 37, wherein the paper record is a receipt.

39. The system of claim 38, wherein the paper record is at least one coupon denoting at least a portion of the volume of fuel purchased, which is redeemed for at least a portion of the volume purchased.

40. The system of claim 25, wherein the banking record is stored on a computer readable medium.

41. The system of claim 40, wherein the computer readable medium is a magnetic strip of a card.

42. The system of claim 40, wherein the electronic record is stored on a card having an embedded microprocessor and computer readable memory.

43. A system for bulk selling and banking a volume of fuel comprising:
a. a fuel selling location for selling a volume of fuel to a purchaser, wherein the fuel selling location includes a means for creating a banking record of the sold fuel and presenting the record to the purchaser; and,
b. a fuel dispensing location, affiliated with the fuel selling location, for receiving the banking record and a request to dispense a portion of the volume purchased, which is less than the volume purchased, and a means for dispensing the requested portion, wherein the fuel dispensing location includes a means for amending the banking record to reflect the volume of sold fuel available for further dispensing.

44. The system of claim 43, wherein the fuel selling location further includes a means for transmitting a copy of the banking record to a banking record database.

45. The system of claim 43, wherein the fuel dispensing location further includes:
a. a means for receiving the banking record;
b. a means for querying a banking record database for a stored banking record corresponding to the received banking record;
c. a means for comparing the stored banking record with the received banking record;
d. a means for verifying that the received banking record matches the stored banking record; and,
e. a means for confirming that the measure of the volume of fuel available for dispensing is at least equal to the requested volume of fuel.
